(19) United States
(12) Patent Application Publication
(10) Pub. No.: US 2013/0187049 A1
(43) Pub. Date: Jul. 25, 2013

(54) SPECTRAL FILTER HAVING A STRUCTURED MEMBRANE AT THE SUB-WAVELENGTH SCALE, AND METHOD FOR MANUFACTURING SUCH A FILTER

(71) Applicants: Stéphane Collin, Paris (FR); Grégory Vincent, Paris (FR); Riad Haidar, Paris (FR); Jean-Luc Pelouard, Paris (FR); Nathalie Bardou, Forges Les Bains (FR); Martine Laroche, Paris (FR)

(72) Inventors: Stéphane Collin, Paris (FR); Grégory Vincent, Paris (FR); Riad Haidar, Paris (FR); Jean-Luc Pelouard, Paris (FR); Nathalie Bardou, Forges Les Bains (FR); Martine Laroche, Paris (FR)

(73) Assignee: CENTRE NATIONAL DE LA RECHERCHE SCIENTIFIQUE-CNRS, Paris (FR)

(21) Appl. No.: 13/807,793

(22) PCT Filed: Jun. 27, 2011
(86) PCT No.: PCT/EP2011/060694

§ 371 Date: Mar. 11, 2013

(30) Foreign Application Priority Data
Jun. 29, 2010 (FR) 1055226

(51) Int. Cl. G02B 5/26; G01J 5/08

(52) U.S. Cl. CPC G02B 5/26; G01J 5/0862
USPC 250/338.1; 359/885; 359/887; 216/24

(57) ABSTRACT

According to a first aspect, the present invention relates to a spectral filter suitable for filtering an incident wave at at least a first given central wavelength λ₀ comprising a substrate with a through orifice and a membrane of dielectric material. The membrane is suspended above the orifice and is structured to form a set of rods organized in the form of a two-dimensional pattern (33) repeated in two directions (D₁, D₂), the repetition of the pattern in at least one direction being periodic or quasi-periodic, with a first period (T₁) less than the central wavelength λ₀.

### FIELD OF THE INVENTION

The present invention relates to the field of spectral filters with membranes structured on a subwavelength scale, and more particularly the field of spectral filters used for the radiation of wavelengths in the infrared spectral band.

### STATE OF THE ART

Spectral filters are known that are made up of stacks of thin layers (interferential filters). However, since they involve a large number of thin layers, these components exhibit a fragility when they are subjected to temperature variation cycles, for example when they are arranged in a cryostat, notably for applications in the infrared. In practice, these cycles lead to an embrittlement of the structure because of the heat expansion coefficients which differ from one material to the other and therefore from one layer to the other, resulting in stresses between the layers and a risk of delamination by shearing. Furthermore, a filter operating in the infrared will require thicker layers than a filter operating in the visible, and very rapidly there will be technological difficulties linked to the thickness. In particular, the characteristics of the filter (spectral width and position) being directly linked to the thickness, it is extremely complicated to juxtapose different filters on one and the same component, which can prove useful for multispectral applications for example.

For ten or so years now, various theoretical works have predicted singular optical properties for membrane structures formed from subwavelength patterns. In R. Magnusson and S. S. Wang, “New principle for optical filters’, Appl. Phys. Lett., 61(9):1022-1024, 1992, for the first time, a theoretical study demonstrated the possibility of a selective reflection of virtually 100% in a subwavelength dielectric grating deposited on a support. A geometrical resonance mechanism has been revealed by R. Gomez-Medina (‘Extraordinary optical reflection from sub-wavelength cylinder arrays’, Optics Express, Vol. 14, No. 9, May 2006) to explain the reflection peaks in an array of cylindrical rods in the absence of plasmonic modes. Ye et al. (‘Rigorous reflectance performance analysis of Si₃N₄ self-suspended subwavelengths gratings’, Optics Communications 270 (2007) 133-237) have studied in more detail the influence on the reflection of a polarized incident wave TM of the optogeometrical parameters of a membrane made of dielectric material structured on a subwavelength scale, in a configuration of a self-suspended membrane. These different theoretical studies have shown that, to obtain a reflection that is selective and adjustable in wavelength, it is necessary to have a structure that has a symmetry in relation to a plane parallel to the plane of the membrane, and preferentially in a dielectric environment of low index, typically air. This assumes very strong constraints in terms of manufacture, which has considerably limited the experimental studies of these structures.

Recently, the paper by Gregory Vincent et al., ‘Large area dielectric and metallic freestanding gratings for mid-infrared optical filtering applications’, J. Vac. Sci. Technol. B26(6), 3 Nov. 2008, presented a method for manufacturing metallic or dielectric self-suspended nanostructured membranes, showing the feasibility of bandpass or band-cut filters, notably in the infrared, and possible applications in multispectral infrared cameras.

Nevertheless, the manufacture of suspended membranes produced in this way presents difficulties, notably linked to a fragility of the structure, limiting in particular the size of the membranes. Moreover, it has been proved that, in use, these filters showed a limited stability in their optical efficiency, notably due to the vibrations of the membrane when subject even to the slightest atmospheric disturbances.

One object of the present invention is to present a spectral filter with subwavelength dielectric membrane for the filtering of visible or infrared radiation which notably exhibits a better robustness and a greater stability in optical efficiency in use.

### SUMMARY OF THE INVENTION

According to a first aspect, the invention relates to a spectral filter suitable for filtering an incident lightwave by reflection of said wave in a spectral band centered on at least one given first central wavelength λ₀, the filter comprising a substrate with a through orifice and a membrane formed from dielectric material. The membrane is suspended above the orifice and is structured to form a set of rods organized in the form of a two-dimensional pattern repeated in two directions, the repetition of the pattern in at least one direction being periodic or quasi-periodic, with a first period less than the central wavelength λ₀. The organization of the rods of a filter produced in this way has shown, notably compared to the filters of the prior art, significantly enhanced properties of robustness and of optical stability.

For example, and in a nonlimiting manner, the dielectric material is chosen from silicon dioxide, manganese oxide, silicon carbide, silicon nitride, zinc sulfide, yttrium trifluoride, alumina.

According to a variant, the width of a rod is substantially less than λ₀/2n where n is the refraction index of the material of which the membrane is formed.

The rods can have a section of substantially square, rectangular or circular form, this last variant making it possible to obtain a filter of greater selectivity.

According to a first embodiment of the first aspect of the invention, the pattern has a form of parallelogram type. The membrane is then structured to form a two-dimensional grating with first rods parallel to a first direction and second rods parallel to a second direction, the first rods being formed by the repetition according to said first period of a first sub-pattern comprising at least one rod.

The first sub-pattern may comprise one or a plurality of parallel rods, making it possible to adapt the spectral response of the filter.

According to a variant, the first direction and the second direction are substantially at right angles.

According to a variant, the second rods are also formed by the repetition according to a second period of a second sub-pattern comprising at least one rod per period.

According to a variant, the second period is less than the central wavelength λ₀.

According to a first example, the second period is identical to the first period and the first and second sub-patterns are similar, rendering the structure symmetrical and making it possible notably to produce a filter that is insensitive to the polarization of the incident wave. According to a second example, the second period is different from the first period, allowing, for example, a spectrally selective filtering according to the polarization of the incident wave.

According to a variant, two second adjacent rods are spaced apart by a minimum distance, substantially greater than three times the central wavelength λ₀. The filter then has an optical response close to that of a filter with a membrane structured with one dimension, while having an enhanced robustness and reliability.

According to another embodiment, the pattern may comprise rods arranged in at least three different directions, notably making it possible to obtain a better angular acceptance while retaining a certain degree of insensitivity to the polarization of the incident wave.

According to a second aspect, the invention relates to a multispectral matrix comprising a plurality of spectral filters according to the first aspect suitable for filtering different central wavelengths, the membranes of the filters being suspended above one and the same substrate. Such a matrix exhibits a robustness and an optical stability despite the greater dimensions and retains a constant thickness, the filtering wavelength of each filter being determined by the patterns of the structured membrane and not its thickness.

According to a third aspect, the invention relates to an infrared imaging system comprising an infrared detector and a filter according to the first aspect or a multispectral matrix according to the second aspect, said filter or said matrix being used in transmission mode or in reflection mode.

According to a variant, the imaging system comprises means for rotating the filter or the matrix, making it possible to vary the angle of incidence of the incident wave on said filter(s) in order to obtain one or more wavelength-tunable filters.

According to a fourth aspect, the invention relates to a method for manufacturing a spectral filter suitable for filtering by reflection of an incident wave in a spectral band centered on at least one first given central wavelength λ₀ comprising:
the deposition of a thin layer of dielectric material on one face of a substrate;
the etching of said thin layer of dielectric material to obtain a membrane structured to form a set of rods organized in the form of a two-dimensional pattern repeated in two directions, the repetition of the pattern in at least one direction being periodic or quasi-periodic, with a period less than the central wavelength λ₀;
the etching on an opposite face of the substrate of an orifice passing through the substrate such that the structured membrane is suspended above the orifice.

According to a variant, the method also comprises an isotropic etching of the rods, for example by immersion of the duly obtained filter in a solution of a diluted acid allowing for a controlled attack of the material of which the rods are made in order to round and/or reduce the section of said rods in a controlled manner.

### BRIEF DESCRIPTION OF THE FIGURES

Other features and advantages of the invention will emerge from reading the following description, illustrated by the figures in which:

FIG. 1 represents a cross-sectional view of an exemplary embodiment of a filter according to the invention.

FIG. 2 is a diagram schematically illustrating steps of a method for manufacturing a self-suspended membrane according to one embodiment of the invention.

FIG. 3 represents an image taken by scanning electron microscope of a self-suspended structured membrane for a filter according to a variant of the invention.

FIG. 4 is a graph showing the measured transmission spectrum of a filter with membrane according to the embodiment illustrated in FIG. 2.

FIG. 5 is a graph representing measured transmission spectra of a filter with membrane according to the embodiment illustrated in FIG. 2, for different angles of incidence.

FIG. 6 represents an image taken by scanning electron microscope of a self-suspended structured membrane for a filter according to another variant of the invention.

FIG. 7 is a graph showing the measured transmission spectra of a filter with membrane of the type of FIG. 6, respectively in TE and TM modes.

FIGS. 8A and 8B illustrate two examples of structured membranes according to two embodiments of a filter according to the invention.

FIGS. 9A and 9B illustrate variants of structured membranes of a filter according to the invention, respectively with patterns in hexagon and parallelogram form showing triangles.

FIG. 10 illustrates a multispectral matrix incorporating a plurality of filters in one embodiment of the invention.

### DETAILED DESCRIPTION

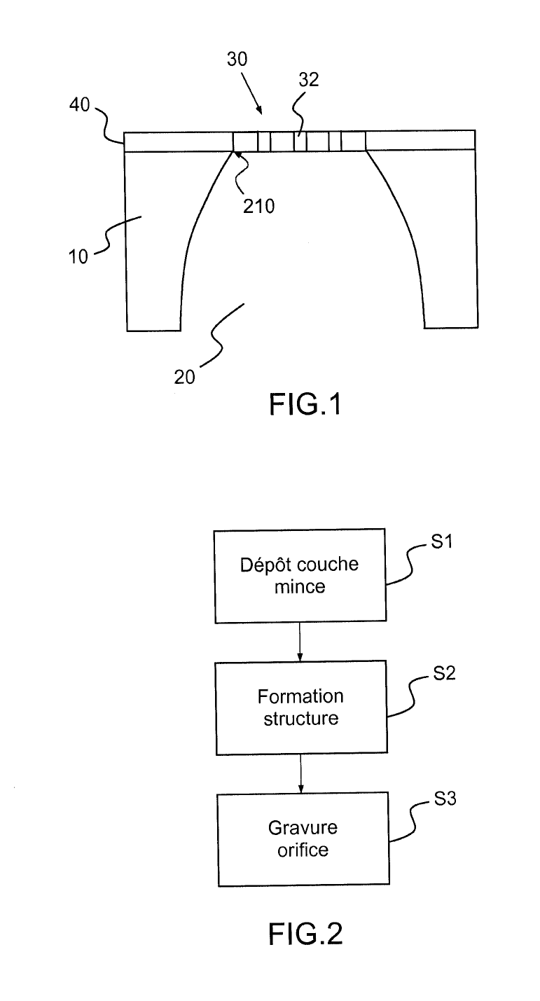

FIG. 1 represents a cross-sectional view of a filter equipped with a self-suspended membrane in an exemplary embodiment of the invention. This is an illustrative diagram in which the elements are not represented to true scale. The filter generally comprises a substrate 10, an orifice 20 passing through the substrate 10 and a structured membrane 30 suspended above the orifice 20.

The membrane is formed from dielectric material. “Dielectric material” should be understood to mean, generally, a material or a stack of materials whose dielectric permittivity has a positive real part and an imaginary part that is zero or very low compared to the real part.

The membrane is structured to faun a set of rods organized in the form of a two-dimensional pattern, the pattern being repeated in two directions. The pattern may comprise rods arranged in two directions, it is then, for example, or parallelepipedal, rectangular or square form. It may take other forms, with rods arranged in at least three directions, for example a hexagon form, or indeed exhibit a complex structure with rods arranged according to an outline and within this outline, as will be described hereinbelow. In FIG. 1, only first rods 32 can be seen in cross section. The substrate 10 is, for example, a substrate made of silicon, of thickness typically in the order of a few hundred micrometers. In use, the filter can be used in transmission mode (band-cut) or in reflection mode (bandpass).

FIG. 2 provides a simplified description of the steps of an exemplary method for manufacturing a bandpass filter according to the invention, for example of the type of that described in FIG. 1. In a first step S1, a layer 40 of dielectric material is deposited on the front face of a substrate 10 (face intended to receive the incident light, see FIG. 1). The deposition can be performed by a plasma-assisted gaseous phase chemical deposition technique. A thickness of the layer 40 of dielectric material is generally between 0.5 microns and a few microns. The dielectric material may be, for example, a nitride such as silicon nitride (Si₃N₄), a carbide such as silicon carbide (SiC), an oxide such as silicon dioxide (SiO₂), manganese oxide (MnO), alumina (Al₂O₃), a sulfide such as zinc sulfide (ZnS), a fluoride such as yttrium trifluoride (YbF₃). In a second step S2, the structured membrane 30 is formed by using, for example, a UV or electronic lithography method so as to obtain a grating with the desired pattern. In a third step S3, the orifice 20 is etched on the rear face of the substrate 10 according to a given pattern (square, rectangular, etc. aperture). The orifice 20 passes through the substrate 10 such that the membrane 30 is suspended at a peripheral portion of an aperture 210 of the orifice 20. The etching of the substrate 10 can be performed, for example, by chemical etching in a bath of tetramethylammonium hydroxide (TMAH). Prior to the chemical bath, a rear face of the substrate 10 can be covered with a layer of silicon oxide (SiO₂) including a passage for the TMAH. This makes it possible to selectively etch the rear face of the substrate. The form of the passage on the layer of silicon oxide deposited on the rear of the substrate 10 is linked to the form of the orifice 20 obtained by etching. It is also possible to protect the front face and the structure with one or more protection layers. Typically, the surface area of the aperture 210 of the orifice 20 on the front face of the substrate 10 is of the order of from a few square millimeters to several hundred square millimeters.

The method thus described makes it possible to obtain a suspended structured membrane 30, the two-dimensional pattern of which makes it possible to confer a rigidity on the structure. Notably, the presence of rods arranged in different directions makes it possible to prevent a transversal movement of the rods in case of vibrations during use. The applicants have thus found a significantly better stability in optical performance levels, making it possible to test filters produced in this way in conditions of use, which had not been possible hitherto with the suspended membranes of the prior art.

With the method described previously, rods are obtained with a section that is substantially square or rectangular. According to a preferred variant of the method, it is possible to obtain rods whose sectional form tends toward a rounded form. For this, the sample undergoes an isotropic etching of its rods, for example by dipping it in a solution of a diluted acid, which chemically attacks the material of which the rods are made. The isotropic etching is faster on the edges of the rods. It makes it possible to round and then reduce the section of the rods in a controlled manner. Rods of very small sections can thus be manufactured easily. In the case of rods of silicon nitride, this chemical etching can be done, for example, in a dilute solution of hydrofluoric acid (HF), for a few minutes.

The applicants have shown that rods with a substantially round section allowed, notably by reduction of the size and of the roughness of the rods, for a better selectivity in the filtering function.

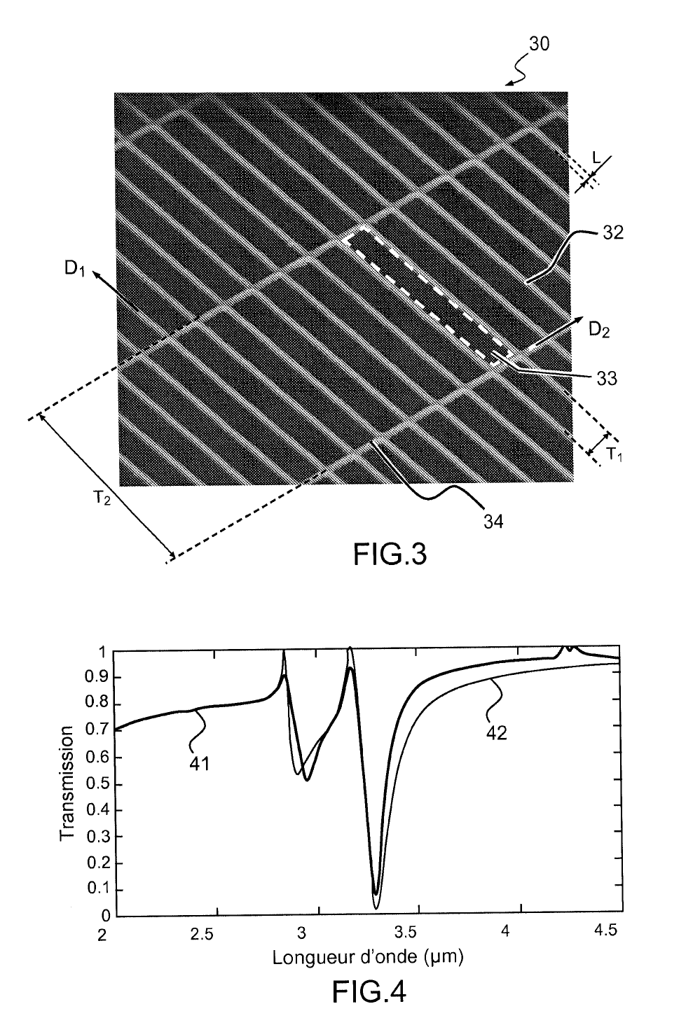

FIG. 3 illustrates a first example of a structured membrane for the production of a filter according to the invention. This is an image taken by scanning electron microscope of a membrane produced according to the method described previously. In this example, the membrane 30 is structured to form a two-dimensional grating with first rods 32 parallel to a first direction D₁ and second rods 34 parallel to a second direction D₂. The first rods 32 are arranged periodically according to a first period T₁ and the second rods 34 are also arranged periodically, but with a period T₂ greater than T₁. The two directions D₁ and D₂ are substantially at right angles and the rods are organized in the form of a substantially rectangular pattern 33 repeated in each of the directions. In this example, the periods T₁ and T₂ are respectively equal to approximately 3 μm and 20 μm, the width of the rods is approximately 500 nm and the rods are of substantially square section.

FIG. 4 represents the transmission spectrum 41 measured for the spectral filter represented in FIG. 3, with an incident wave in a plane of incidence at right angles to the rods 32, exhibiting an angle of incidence of 5° defined in relation to the normal to the plane of the membrane and a polarization of the incident electrical field parallel to the first rods 32 (polarizations TE). The spectral response 41 is compared with the calculated spectrum 42 of a one-dimensional structure, having the same number of first rods 32 arranged with the same period T₁, for a similar incident wave. The filter obtained according to this embodiment exhibits a very selective optical resonance phenomenon around 33 μm. The transmission coefficient reaches 0.03 at the cut-off wavelength. In this example, the spectrum exhibits a second dip around 2.9 μm. The presence of this second dip is explained by the non-zero angle of incidence, the two peaks (2.9 μm and 3.3 μm) being situated on either side of the cut-off resonance expected around 3 μm with normal incidence (wavelength close to the value of the period T₁ of arrangement of the rods 32).

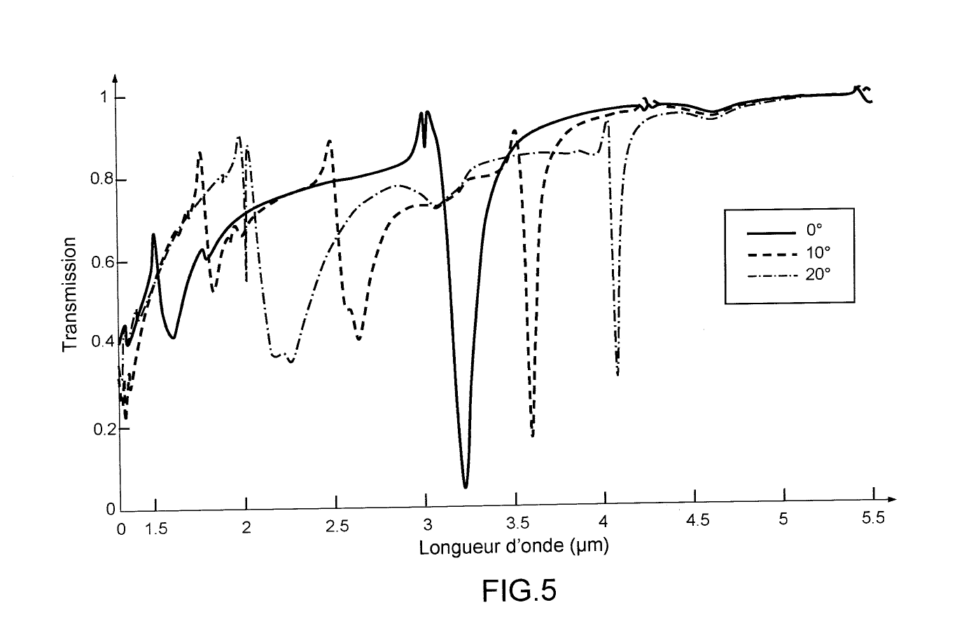

FIG. 5 thus illustrates transmission spectra of the spectral filter represented in FIG. 3, measured for a plurality of angles of incidence (respectively 0°, 10°, 20°). At normal incidence, a main dip is observed, centered around the 3.2 μm wavelength. When the angle of incidence increases, the appearance of two dips on either side of the central wavelength is observed. The appearance of a second resonance mode is explained by the non-zero angle of incidence. It is thus possible, by modifying the angle of incidence and by filtering one side of the central wavelength, to adjust the filtering wavelength.

The comparison of the spectra 41 and 42 in FIG. 4 reveals that a structure of the type of FIG. 3 makes it possible to obtain a filtering which approaches the filtering of a one-dimensional structure of the same period T₁ and of the same direction D₁. The applicants have shown in fact that, by choosing second rods 34 spaced apart by a minimum value substantially equal to three times the wavelength, it would be possible to obtain a bandpass filter with optical behaviors substantially identical to that of a one-dimensional membrane, but with significantly greater robustness and stability.

As with a structured membrane in one dimension, the cut-off wavelength depends on the period of the rods 32 spaced apart with a subwavelength period and the filter obtained is polarizing, only the polarization TE being reflected by the resonant mechanism. On the other hand, the wave transmitted at the cut-off wavelength is polarized according to the polarization TM. Such a filter can be used in transmission mode (band-cut filter) or in reflection mode (bandpass filter), for example in an imaging system.

The applicants have shown that the resonant reflection mechanism revealed both by theory and experimentally could be explained by a multiple scattering mechanism. In other words, for a given wavelength which depends on the geometry of the structure, a coherence is observed between the waves scattered by each of the rods of the structure. This is reflected in the observation at said wavelength of a specular reflection, said wavelength depending on the angle between the incident light and the normal to the plane of the membrane, as is shown in FIG. 5.

According to an exemplary application, such a filter can be used to analyze the polarization of a scene. For example, the polarization analysis system may comprise an infrared imaging system with said spectral filter optimized for filtering at a given cut-off wavelength in the infrared spectral band, a detector sensitive to the cut-off wavelength of the filter and a device for rotating the polarization of the incident wave. If the incident wave comprises a component with a linear polarization, which is, for example, the case of an infrared radiation emitted by an artificial object (of vehicle or building type for example), the signal measured in transmission mode will be variable with the position of the polarization rotation device (and minimal, for example, when the incident polarization is TE). If the incident wave is purely non-polarized (typically the case of an infrared radiation emitted by a natural object, of vegetation type), the signal in transmission mode will be constant regardless of the position of the polarization rotation device.

According to another variant of the invention, second rods 34 can be arranged periodically according to a period T₂ of the order of the period T₁ of the first rods 32. The periodic arrangement of the first rods 32 in a direction D₁ with a period T₁ makes it possible to obtain a filtering effect around a first cut-off wavelength λ₁ that is a function of T₁ for a component of the incident electrical field parallel to the direction D₁. The periodic arrangement of the second rods 34 with a period T₂ close to T₁ makes it possible to obtain a filtering effect at a second cut-off wavelength λ₂ close to λ₁ for a component of the incident electrical field parallel to the direction D₂. A spectral filter with a membrane structured in this way allows, for example, for a selective wavelength filtering, produced by selecting the polarization of the incident wave.

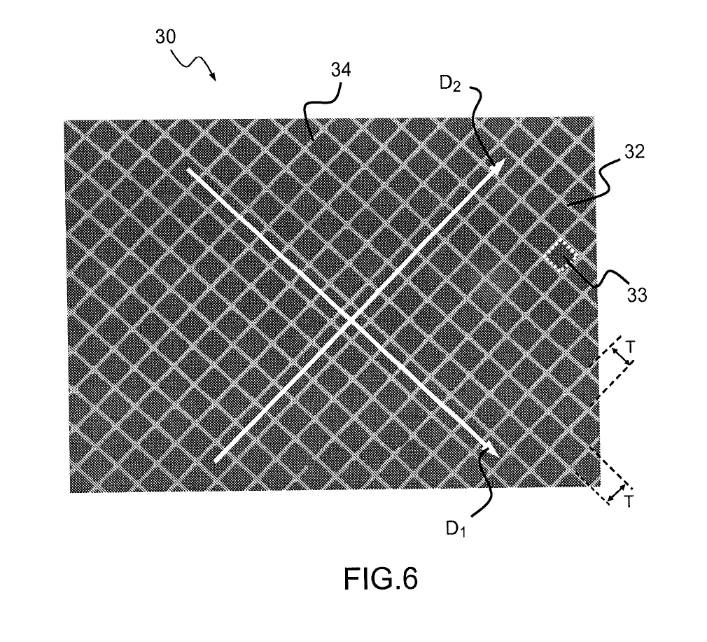

FIG. 6 illustrates a scanning electron microscope image of an exemplary structured membrane 30 manufactured by using the method described previously, comprising first and second rods 32 and 34 of substantially square section of 500 nm size, the rods being respectively parallel to two directions D₁ and D₂ at right angles and being arranged according to a same period T of the order of 3 μM. The rods are thus organized in this example in the form of a substantially square pattern 33 repeated in each of the directions. Since the period of the first and second rods is identical, the cut-off wavelengths λ_{c} for an incident wave polarized with a polarization TE in the direction D₁ and D₂ are identical. In normal incidence, this makes it possible, notably, to switch off the wavelength λ_{c} in a radiation transmitted independently of the polarization of the incident wave. In this example, the first and second rods have the same width and the same thickness, and the width of the resonance is therefore identical for the components of the field in the directions D₁ and D₂. Thus, in this example, in addition to the qualities of robustness and stability of the filter produced in this way, the incident wave transmitted by the membrane is spectrally filtered independently of the polarization of the incident field.

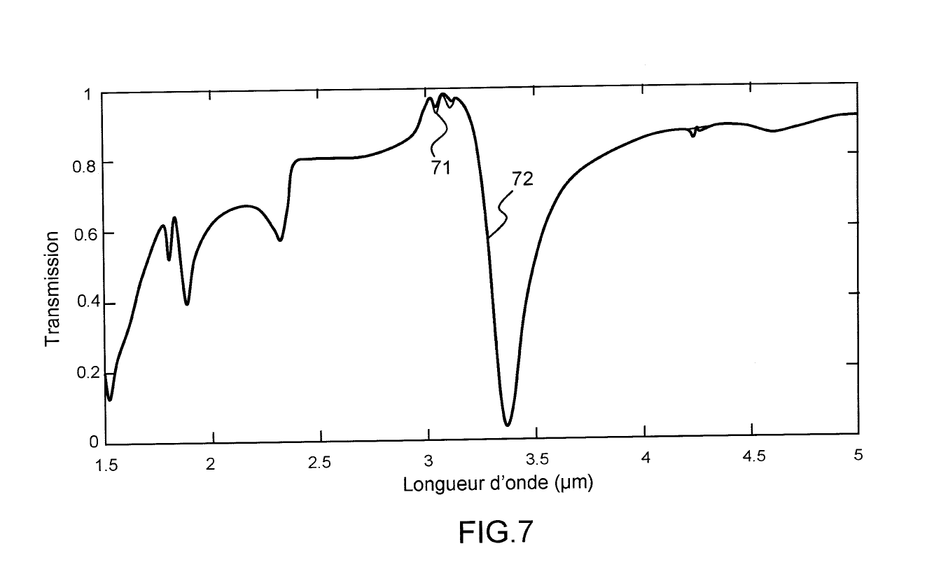

FIG. 7 illustrates the transmission spectra 71, 72 measured in normal incidence of the filter as represented in FIG. 6, respectively for an incident wave whose electrical field is oriented in the direction D₁ and for an incident wave whose electrical field is oriented in the direction D₂. These curves verify that the transmission spectra are superimposed.

As for the examples described previously, such a filter can be used in reflection mode or in transmission mode, for example in an imaging system.

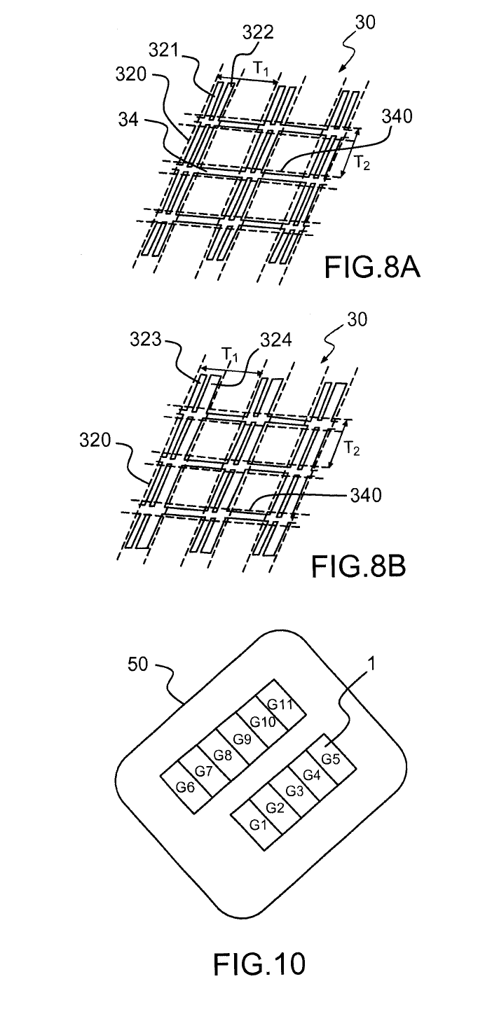

According to another variant of the invention, the membrane can be structured to form a two-dimensional grating with first rods 32 parallel to a first direction and second rods 34 parallel to a second direction, the first rods being formed by the repetition according to the first period (T₁) of a first sub-pattern 320 comprising a plurality of rods. Such a structure makes it possible to obtain a multi-resonant filter for a component of the electrical field parallel to the direction of the first rods. FIG. 8A illustrates an example of such a structure. The structure 30 is obtained in this example by the repetition in two non-parallel directions of a first sub-pattern 320 comprising two rods 321 and 322 per period and of a second sub-pattern 340 comprising one rod 34 per period. In the example of FIG. 8A, the two rods 321 and 322 of the first sub-pattern 320 have identical sections, for example circular, and the periods of the first and of the second sub-patterns are substantially identical, the main pattern according to which the rods are organized being substantially square.

In the embodiment illustrated in FIG. 8B, the sub-pattern 320 comprises two rods 323 and 324 per period but the rod 323 has a smaller section than the section of the rod 324. Generally, a variation of section of the rods of the structure makes it possible to modify the width of the resonance around the cut-off wavelength.

In other embodiments, the first sub-pattern and/or the second sub-pattern may comprise more than two rods. The rods of the first sub-pattern and/or of the second sub-pattern may be spaced apart regularly within the sub-pattern or be spaced apart irregularly and may be of different section. These adjustments make it possible to adapt the spectral response of the nanostructured membrane to obtain specific optical effects.

For example, the structure may be symmetrical relative to the bisector of the directions D₁ and D₂ with the same number of sub-patterns per period, making it possible to produce a spectral filter that is insensitive to the polarization.

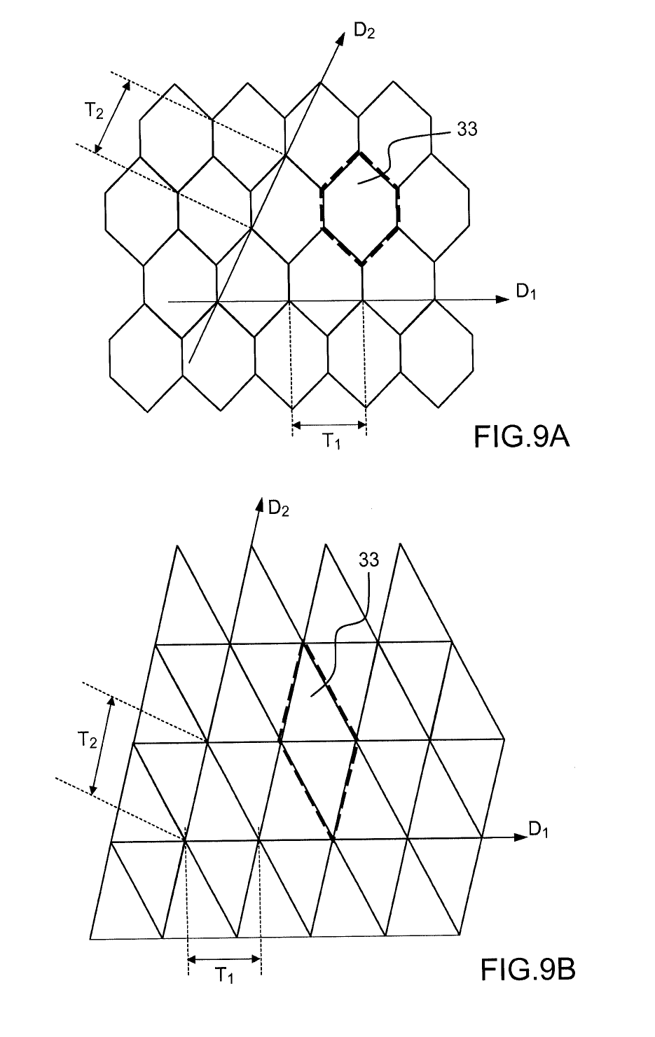

FIGS. 9A and 9B illustrate variants of patterns according to which the rods of the membrane can be organized. In the example of FIG. 9A, the pattern 33 is hexagonal, repeated periodically in two directions D₁ and D₂ with periods T₁ and T₂. In the example of FIG. 9B, the pattern 33 is complex, with a general parallelogram form, one rod also being arranged on a diagonal of the parallelogram, the pattern here once again being repeated periodically in two directions D₁ and D₂ with periods T₁ and T₂. In each of these examples, in addition to the robustness expected of the structure by virtue of a two-dimensional pattern, a transmission mode response of the filter with a greater angular acceptance is expected, while preserving insensitivity to the polarization.

According to a variant, the pattern according to which the rods are organized may be repeated quasi-periodically, that is to say with a period with slow variation. In practice, it appears that the filtering function is effective when the number of repetitions of the pattern is at least equal to the quality figure of the filter, defined as the ratio of the central filtering wavelength to the spectral width at mid-height. Thus, typically, for a filter suitable for filtering at 3 μm and a spectral width at mid-height of 0.1 μm, the aim will be to arrange at least thirty rods in the direction of periodicity (for a simple pattern consisting of one rod). The applicants have shown that if the period varies slowly, that is to say by a value substantially less than the spectral width at mid-height for a number of rods substantially equal to the quality figure, it would be possible to retain the filtering function while making the filtering wavelength slip. For example, the variation of the period may be a linear function of the distance, in the direction of periodicity of the pattern.

It is then possible to produce, for example for a spectro-imager function, a filter structured in two directions. In the first direction, the quasi-periodic repetition provides a filtered response for which the cut-off wavelength λ₀ varies continuously from one end to the other of the filter, covering an entire spectral range. For example, a filter 10 mm long in this first direction makes it possible to cover the entire transmission band II of the atmosphere (3 to 5 microns) with a spectral offset of Δλ/5 over Q rods where Q is the quality figure and Δλ the width at mid-height of a periodic filter. In the second direction, a minimum periodicity substantially equal to three times the wavelength provides, for example, a non-filtered transmission.

FIG. 10 illustrates a multispectral matrix 50 comprising a plurality of juxtaposed spectral filters 1. The filters 1 can be adapted to exhibit different spectral responses. For example, the filters 1 may be adapted to filter several juxtaposed spectral bands. This can make it possible to analyze an image over successive wavelength bands. Compared to a prior technique of stacking thin layers, the structured membranes according to the invention have a thickness that is virtually independent of their optical properties. The spectral response of the structured membranes according to the invention can in fact be determined primarily by the period of the rods on the suspended structure and by the material chosen to form the structure. Since the structure produced is, moreover, more robust and more stable optically by virtue of the organization of the rods in the form of a two-dimensional pattern repeated in two directions, the manufacture of a multispectral matrix 50 of constant thickness with a plurality of filters is made possible.

Although described through a certain number of detailed exemplary embodiments, the spectral filter and the method for producing the spectral filter according to the invention comprise different variants, modifications and refinements which will obviously become apparent to the person skilled in the art, given that these different variants, modifications and refinements fall within the scope of the invention, as defined by the following claims.

1. A spectral filter suitable for filtering an incident wave by reflection of said wave in a spectral band centered on at least one first given central wavelength λ₀, comprising:
a substrate with a through orifice, and
a membrane formed from dielectric material, said membrane suspended above the orifice and structured to form a set of rods organized in the form of a two-dimensional pattern repeated in two directions, the repetition of the pattern in at least one direction is periodic or quasi-periodic, with a first period less than the central wavelength λ₀.

2. The spectral filter of claim 1, wherein said dielectric material is at least one of silicon dioxide, manganese oxide, silicon carbide, silicon nitride, zinc sulfate, yttrium trifluoride, and alumina.

3. The spectral filter of claim 1, wherein the width of a rod is substantially less than λ₀/2n, wherein n is the index of the material of which the membrane is formed.

4. The spectral filter of claim 3, wherein the rods have a section of substantially circular, square or rectangular form.

5. The spectral filter of claim 1, wherein said pattern takes the form of a parallelogram, said membrane structured to form a two-dimensional grating with first rods parallel to a first direction and second rods parallel to a second direction, said first rods formed by the repetition according to said first period less than the central wavelength λ₀ of a first sub-pattern comprising at least one rod.

6. The spectral filter of claim 5, wherein said first sub-pattern comprises a plurality of parallel rods.

7. The spectral filter of claim 5, wherein the first direction and the second direction are substantially at right angles.

8. The spectral filter of claim 5, wherein the second rods are formed by the repetition according to a second period of a second sub-pattern comprising at least one rod per period.

9. The spectral filter of claim 8, wherein the second period is less than the central wavelength λ₀.

10. The spectral filter of claim 9, wherein said second period is identical to said first period and said first and second sub-patterns are similar.

11. The spectral filter of claim 9, wherein said second period is different from said first period.

12. The spectral filter of claim 5, wherein two second adjacent rods are spaced apart by a distance substantially greater than three times the central wavelength λ₀.

13. The spectral filter of claim 1, wherein said pattern comprises rods arranged in at least three different directions.

14. A multispectral matrix (40) comprising:
a plurality of spectral filters of claim 1, suitable for filtering different central wavelengths, the membranes of the filters suspended above one and the same substrate.

15. An infrared imaging system comprising:
an infrared detector; and
a filter of claim 1, said filter used in transmission mode or in reflection mode.

16. The imaging system of claim 15, further comprising:
means for rotating said filter to vary the angle of incidence of the incident wave on said filter to obtain one or more wavelength-tunable filters.

17. A method for manufacturing a spectral filter suitable for filtering an incident light wave by reflection of said wave in a spectral band centered on at least one first given central wavelength λ₀, the method comprising:
depositing a thin layer of dielectric material on one face of a substrate;
etching said thin layer of dielectric material to obtain a membrane structured to form a set of rods organized in the form of a two-dimensional pattern repeated in two directions, the repetition of the pattern in at least one direction is periodic, with a first period less than the central wavelength λ₀; and
etching on an opposite face of the substrate an orifice passing through the substrate such that the structured membrane is suspended above the orifice.

18. The manufacturing method of claim 17, further comprising:
immersing the duly obtained filter in a solution of a diluted acid allowing for a controlled attack of the material of which the rods are made in order to round or reduce the section of said rods.
